(19) United States
(12) Patent Application Publication
(10) Pub. No.: US 2020/0234606 A1
(43) Pub. Date: Jul. 23, 2020

(54) PERSONALIZED EDUCATIONAL PLANNING BASED ON USER LEARNING PROFILE

(71) Applicant: International Business Machines Corporation, Armonk, NY (US)

(72) Inventor: Kelley ANDERS, East New Market, MD (US)

(21) Appl. No.: 16/253,420

(22) Filed: Jan. 22, 2019

(51) Int. Cl. G09B 7/00

(52) U.S. Cl. CPC G09B 7/00

(57) ABSTRACT

Methods, computer program products, and systems are presented. The methods include, for instance: collecting instances of user learning data and user personal data for a user and analyzing for common attributes. A user learning profile is generated by modeling the instances of the user learning data and the user personal data with a linear regression matrix. A course recommendation is produced based on the user learning profile, user-topic preferences, and contents of an educational knowledge base. The course recommendation and the user learning profile is presented to the user. Various relevant data items are updated if affected by a feedback by the user on the user learning profile and the course recommendation.

### TECHNICAL FIELD

The present disclosure relates to cognitive analytics and educational technology, and more particularly to methods, computer program products, and systems for producing personalized education plans.

### BACKGROUND

With increased availability in Internet access and information technology, as well as changes in recognition of education and needs for continued training, the area of online education and educational technology are growing rapidly. In addition to traditional in-person classroom programs, more and more online courses and new kinds of educational programs are offered, in all areas of education such as conventional degree programs, and job-related training and certifications courses. Accordingly, the online learning environment often has diversified learning options with distinctive characteristics available for a single topic, which are rarely available with in-person classroom programs. Simultaneously on the side of prospective students, individual needs for online learning, time available for any courses, a learning curve, preferences and responsibilities to balance with the workload of a course are often different for each learner.

### SUMMARY

The shortcomings of the prior art are overcome, and additional advantages are provided, through the provision, in one aspect, of a method. The method includes, for instance: collecting, by one or more processor, instances of user learning data and user personal data for a user; analyzing, by the one or more processor, the collected instances the user learning data and the user personal data for common attributes in the collected instances; generating, by the one or more processor, a user learning profile for the user based on the result from the analyzing by modeling with a linear regression matrix; producing, by the one or more processor, one or more course recommendation based on the generated user learning profile, user-topic preferences provided by the user, and contents of an educational knowledge base; presenting, by the one or more processor, the user learning profile and the course recommendation to the user; and updating, by the one or more processor, the user learning profile, the user-topic preferences, and selected contents of the educational knowledge base that are affected by a feedback from the user, on the user learning profile and on the course recommendation.

Additional features are realized through the techniques set forth herein. Other embodiments and aspects, including but not limited to computer program products and systems, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for providing a personalized educational plan based on a user learning profile, in accordance with one or more embodiments set forth herein;

FIG. 2 depicts a flowchart of operations performed by the educational planning engine, in accordance with one or more embodiments set forth herein;

FIG. 3 depicts a flowchart for generating the user learning profile as performed in block 230 of the educational planning engine, in accordance with one or more embodiments set forth herein;

FIG. 4 depicts an exemplary linear regression matrix model with parameters, in accordance with one or more embodiments set forth herein;

FIG. 5 depicts an exemplary weight scheme in the same embodiment as FIG. 4, indicating how each topic to be ranked for generating the course recommendations, in accordance with one or more embodiments set forth herein;

FIG. 6 depicts an exemplary user learning profile in the same embodiment as above, in accordance with one or more embodiments set forth herein;

FIG. 7 depicts exemplary course recommendations as in the same embodiment as above, in accordance with one or more embodiments set forth herein;

FIG. 8 depicts a cloud computing node according to an embodiment of the present invention;

FIG. 9 depicts a cloud computing environment according to an embodiment of the present invention; and

FIG. 10 depicts abstraction model layers according to an embodiment of the present invention.

### DETAILED DESCRIPTION

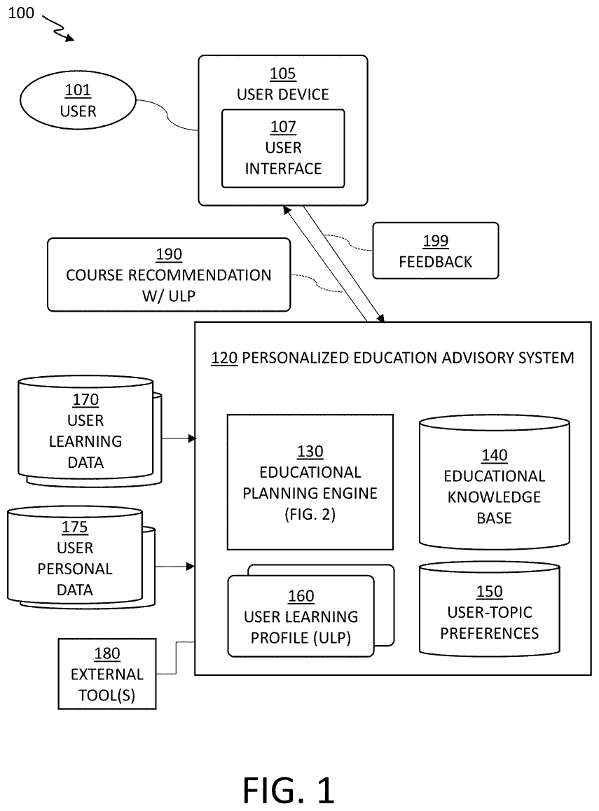

FIG. 1 depicts a system 100 for providing a personalized educational plan based on a user learning profile, in accordance with one or more embodiments set forth herein.

The system 100 includes a personalized education advisory system 120 that provides one or more course recommendation 190 to a user 101, and receives a feedback 199 on the provided course recommendation 190 from the user 101, via a user interface 107 on a user device 105. The user device 105 is any kind of computer system that is operatively coupled to the personalized education advisory system 120. The user device 105 can: run the user interface 107; receive, process, and output display of the course recommendation 190; and take inputs of the feedback 199 from the user 101 and send to the personalized education advisory system 120. Examples of the user device include, but are not limited to, a personal computer, a smartphone, a laptop, etc.

The personalized education advisory system 120 includes an educational planning engine 130, an educational knowledge base 140, user-topic preferences 150, and a user learning profile 160 corresponding to the user 101. The personalized education advisory system 120 includes a plurality of user learning profiles 160 corresponding to respective users, as represented by the user 101.

The educational planning engine 130 of the personalized education advisory system 120 collects data relevant to the user 101 including user learning data 170 and user personal data 175. The educational planning engine 130 subsequently generates the user learning profile 160 for the user 101 and the user-topic preferences 150 by compiling the user learning data 170 and the user personal data 175 that had been collected, according to predefined categories and/or attributes of the respective data. The educational planning engine 130 generates the course recommendations 190, based on the user-topic preferences 150 and the user learning profile 160. The educational planning engine 130 also keeps the educational knowledge base 140 up to date based on the user-topic preferences 150, the user learning profile 160, the course recommendations 190, and the feedback 199 on the course recommendations 190 by the user 101.

In certain embodiments of the present invention, the user 101 can initially input preferences/interests in a certain topic, subject, or a degree, certification, which would not appear in either the user learning data 170 or the user personal data 175. In the same embodiments, the educational planning engine 130 creates or updates the user-topic preferences 150 according to the input on the preferences/interests as provided by the user 101.

In certain embodiments of the present invention, the educational planning engine 130 utilizes a simple linear regression matrix model for analyzing the user learning data 170 and the user personal data 175, and generates the user learning profile 160 as a result. The educational planning engine 130 further analyzes the user learning profile 160 in combination with the user-topic preferences 150, in order to generate the course recommendations 190. The user learning profile 160 includes past educational records with selected attributes, notes on respective past courses with respect to sentiment toward each courses taken and/or special event(s) that occurred during the period of the courses. The user learning profile 160 further includes a certain interrelationships between attributes in the user learning profile 160.

The personalized education advisory system 120 is coupled to one or more external tools 180 for cognitive analysis, data mining, natural language analysis, and machine learning, to compile and to analyze the user learning data 170 and the user personal data 175, in order to generate the user learning profile 160 and the course recommendations 190. The external tools 180 for the respective functionalities are available in subscribed services and/or as proprietary utilities for the personalized education advisory system 120.

The educational knowledge base 140 includes various general knowledge on general education subjects, studies, and statistics, and course choices that are helpful to generate the course recommendation 190 for all subscribers of the educational advisory service, as represented by the user 101. Embodiments of the present invention recognize that various characteristics of numerous candidate courses can be used in selecting one course over another. In certain embodiments of the present invention, the educational knowledge base 140 stores the numerous candidate courses according to the characteristics such that the educational planning engine 130 can check the respective characteristics and values corresponding to the characteristics in order to select a course that best suits the need and preferences of the user 101. The characteristics of the candidate courses include, but are not limited to, topics/subjects, types of time commitment, schedules and durations of respective courses, delivery methods, pace of the deliveries, provider reputations, faculty qualifications, costs, and utility of the credits/topics for individual learners with respect to a particular need of the user 101 such as job-relevancy. For example, respective attributes represented in the educational knowledge base 140 can specify the types of time commitment, or a learning engagement, of which value is to be selected from {full-time, part-time, weekend, mix, weekly hours}, where the value of “full-time” indicates a general course load rule of 15 units, where the value of “part-time” indicates a course load less than 60 percent of the full time units, where the value of “weekend” indicates the course hours are set in the weekends only, where the value of “mix” indicates a combination of the preceding time commitments in one course over distinctive periods, and where the value of “weekly hours” indicates a number of hours estimated for taking a course as specified by a provider/faculty. Similarly, an attribute in the educational knowledge base 140 can specify a schedule of a course by respective dates and hours assigned for each portion of the course, and a duration the course by a number of weeks from the beginning to the end of the course. Similarly, another attribute in the educational knowledge base 140 can specify the delivery methods of the courses by one of {media, classroom, blended}, where “media” value indicates exclusively conducted over on-line or off-line media platforms with personal information technology (IT) devices by live streaming and/or downloading of course materials and by interactive chatting, emailing, and/or messaging for communications and assignment submissions, where “classroom” value indicates exclusively conducted in traditional classroom settings, and wherein “blended” value indicates a combination of online learning and classroom learning with periodic meetings for interactive instructions and/or discussions. Still another attribute in the educational knowledge base 140 can specify the pace of delivery by one of {synchronous, asynchronous}, where “synchronous” value indicates that the course is delivered to all students simultaneously as in classes of traditional classroom settings, which is applicable to “classroom”, “media”, and “blended” delivery methods, and where “asynchronous” value indicates that the course can be individually paced by each student to a varying degree with a certain limitation such as a final exam or a term paper due date, which is applicable only to “media” and “blended” delivery methods.

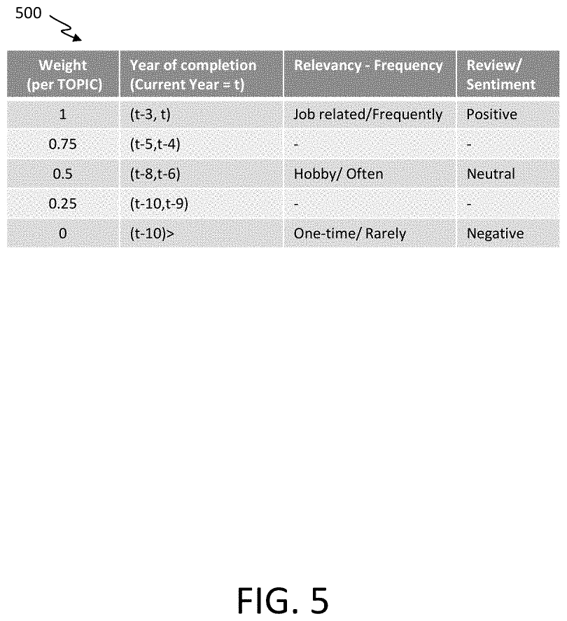

The educational planning engine 130 generates the user-topic preferences 150 by analyzing various aspects of the user learning data 170 and the user personal data 175, according to predefined attributes for preferences of the user 101. Examples of the attributes that can affect the user-topic preferences 150 include, but are not limited to, frequencies respective to courses indicating how many times the user 101 took courses of a certain subject/topic, recencies respective to courses indicating how recently the user 101 had taken the respective courses, relevancies respective to courses indicating how much the user 101 is interested in a certain subject/topic. In certain embodiments of the present invention, the educational planning engine 130 sets a weight for relevancies high for job related topics, medium for a hobby, and low for any courses that had been tried once. With respect to the recencies, in certain embodiments of the present invention, the educational planning engine 130 sets a scale of weights for certain periods of years in the past such that a course taken recently would account more in analysis for the user learning profile 160 and in generating the course recommendations 190 than another course taken a certain number of years, say ten years, ago. An example of a weight scheme is presented in FIG. 5 and corresponding description.

In certain embodiments of the present invention, examples of the user learning data 170 include, but are not limited to, past education records as provided by the user 101 such as transcripts from schools, certificates from respective educational institutions and/or learning centers, award and/or license records by respective hosting authorities, describing respective topics/subjects, a delivery format, evaluation types, a grade earned and/or a certificate awarded, a date of completion, characteristics of the programs and numerous other aspects of each record of the user learning data 170. Examples of the user personal data 175 include, but are not limited to, a present calendar record of the user 101 describing various ongoing schedules and events, social media postings and interactions, a certain number of past calendar records of the user 101 that provides background information for the programs listed in the user learning data 170.

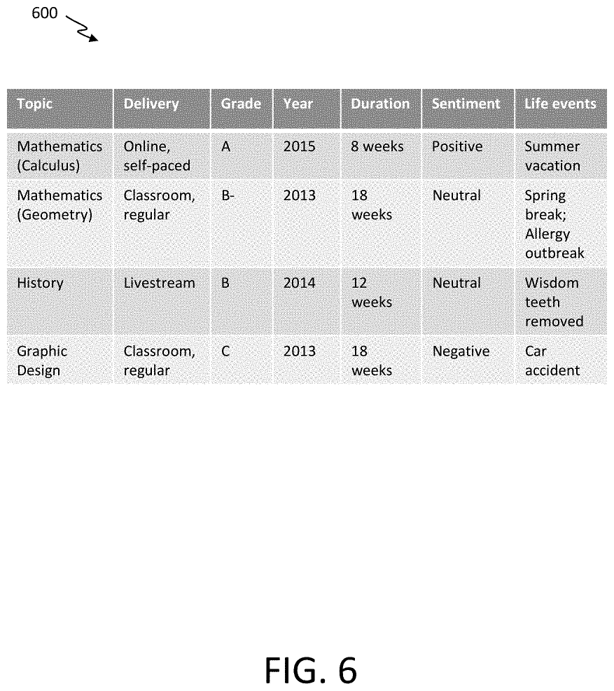

In certain embodiments of the present invention, the educational planning engine 130 combines past courses discovered in the user learning data 170 with items relevant to the respective past courses as discovered of user personal data 175. An example of the user learning profile 160, which is presented in FIG. 6, includes attributes of Topic, Delivery, Grade, Year, Duration, Sentiment, and Life Events, where attributes of Topic, Delivery, Grade, Year, and Duration are obtained from the user learning data 170, and where attributes of Sentiment and Life Events are obtained from the user personal data 175. The attribute of Sentiment can be obtained, for example, from a comment on a past course by the user 101 in social media postings, a calendar record for class hours and notes, or a text message with a friend. The attribute of Life Events can be obtained, for example, from a calendar record for an event within a time period overlapping with values of Year and Duration attributes.

The personalized education advisory system 120 provides users of various educational services to select courses that serves their need, offered in delivery methods most effective for each user that also fit personal schedules. By use of the personalized education advisory service, the users 101 who wants to build a certain skill, to get a certification, or to earn a degree can make an informed decision in taking courses based on the course recommendation 190, and actually achieve individual goals and perform better in the courses so chosen. By offering the personalized education advisory service, educational service providers and institutes can also benefit from effective recruiting target students and effective implementation/delivery of courses in formats most in demand. Also the educational service provides can improve student retention and graduation/completion rates by assisting students to select the most beneficial and achievable goals, in effective delivery formats individually selected from various learning option.

The educational service providers can cumulate teaching profiles for faculty as the user learning profile 160 for the users 101, for better utilizing or for better developing skills of faculty members according to individual subject area and performance edges, specifically in respective delivery vehicles.

As in the user learning profile 160, the educational planning engine 130 can be utilized to generate a personalized sports profile in order to assist in selecting a specific kind of sports that is most effective for an individual for health, or a kind of sports in which an individual has advantage over others, based on inputs of biomechanical characteristics, personality, genetics, and various other personal performance metrics.

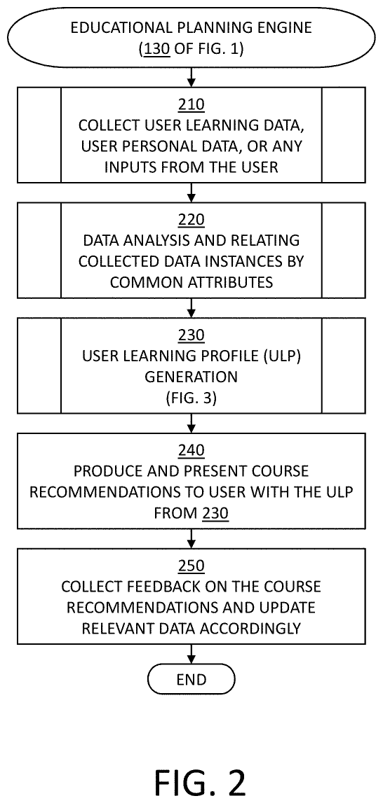

FIG. 2 depicts a flowchart of operations performed by the educational planning engine 130, in accordance with one or more embodiments set forth herein.

In block 210, the educational planning engine 130 collects instances of the user learning data 170 and the user personal data 175 from sources available for the respective instances. The educational planning engine 130 also receives any input from the user 101 that is not accessible or made available by the education planning engine 130. The user 101 can provide inputs on, for example, new needs or interests on topics that the user 101 had no previous experiences that does not appear on either the user learning data 170 or the user personal data 175 to the educational planning engine 130 for developing the user-topic preferences 150 and for optimizing the course recommendation 190 in block 240 below. Then, the educational planning engine 130 proceeds with block 220.

In certain embodiments of the present invention, the educational planning engine 130 searches and discovers various available data sources in collecting the user learning data 170 and the user personal data 175. The educational planning engine 130 can utilize a data mining tool provided as one of the external tools 180 available for the personalized education advisory system 120. As noted, the user learning data 170 include comprehensive records on all education relevant for the user 101 including school records as well as certificates, licenses and awards that shows training and skills with respect to a certain topic. The user 101 can previously authorize release of any instances of the user learning data 170 at respective educational institutions that hold the instances of the user learning data 170, in order to subscribe the personalized education advisory service. Similarly, the user 101 can explicitly authorize the educational planning engine 130 to access information on the user 101 at various sites, programs, and/or data repositories for collecting the user personal data 175 such as past and future calendar events and social media postings. In this specification, term “topic” is used to indicate any subject matter of educational programs such as academic degree programs, occupational training courses, exam preparation courses, certificate programs, or the like. Accordingly, the user learning data 170 can originate from all types of educational providers, including but not limited to, traditional schools and educational institutions, academic and/or occupational learning centers, professional training programs, and hosting authorities of awards, certificates, and licenses. In the same embodiments of the present invention, the user 101 is informed of which data items are subject for collection in order to establish the user learning data 170 and the user personal data 175, and how the collected data items shall be used. The personalized education advisory system 170 maintains a secure and encrypted repository for keeping the user learning data 170 and the user personal data 175 for the educational planning engine 130, and once the user 101 ceases to use the personalized education advisory system 120, any remaining data relevant for the user 101 will be permanently removed and no further access to respective sources of the user learning data 170 and the user personal data 175 will be made.

In block 220, the educational planning engine 130 analyzes the user learning data 170 and the user personal data 175 collected from block 210 for interrelationships amongst attributes of the user learning data 170 and the user personal data 175. The educational planning engine 130 has a set of attributes for each educational courses specified in block 220 or preconfigured as setting for the, based on general course descriptions that are common to most of instances in the user learning data 170. The educational planning engine 130 subsequently relates certain instances of the user learning data 170 and the user personal data 175 based on a predefined group of common attributes of the respective instances. Then, the educational planning engine 130 proceeds with block 230.

In certain embodiments of the present invention, the educational planning engine 130 analyzes the user learning data 170 and the user personal data 175 for any time related attributes, and respectively corresponding values thereof, in order to ascertain which instances from the user learning data 170 and the user personal data 175 are to be related as being simultaneous. For example, the educational planning engine 130 checks respective values for Date, Month, Year, and/or Week attributes of certain events from a calendar of the user personal data 175 against respective values for School Year, Semester, Duration, and/or Award Date attributes from course instances of the user learning data 170. If any time related values of a calendar event and a course instance overlap, the education planning engine 130 relates the calendar event and the course instance as being simultaneous, indicating the calendar event happened while the user 101 was taking the course instance.

In certain embodiments of the present invention, the educational planning engine 130 analyzes texts of any calendar events and/or social media postings from the user personal data 175 for any word indicating a value for a Topic attribute of the user learning data 170, in order to identify any comment on any courses from the user learning data 170.

In certain embodiments of the present invention, the educational planning engine 130 analyzes texts of any calendar events and/or social media postings from the user personal data 175 for vocabularies expressing opinions and attitudes on various aspects of any educational program such as grades, attendances, exams, faculties, schools and educational institutions, learning centers, certificate programs. Such vocabularies can be established in the educational knowledge base 140 by use of the external tools 180, prior to block 220 of the educational planning engine 130. The educational planning engine 130 applies respective aspects commented by the user 101 to attributes of the instances in the user learning data 170 corresponding to the commented aspects.

For example, if the educational planning engine 130 discovers that the user 101 commented “I like watching history documentaries. I really enjoyed one that historians discussed alternative developments of the ABC Event”, or “I read a book about the ABC Event by Jane Doe. Intriguing!” in a social media group posting, then, the educational planning engine 130 identifies “history”, “ABC event”, and “Jane Doe” as keywords that can appear as a value of Topic attribute in instances of the user learning data 170. Further, the educational planning engine 130 identifies a positive attitude, based on the terms “like”, “enjoy”, and “intrigue”, toward the respective instances of the user learning data 170 relevant to the aforementioned keywords.

Similarly, if the education planning engine 130 discovers that the user 101 commented “I don't like quizzes and exercises for every class with this online math course that I'm taking now. I'd rather work on one exam at the end of the courses”, or “I seem to end up in a grade worse than I deserve with multiple choice exams for my history course! How come they are so confusing!”, then the educational planning engine 130 identifies terms “math” and “history” as being relevant to the Topic attribute for instances of the user learning data 170, terms “quiz”, “exercise”, “exam”, “grade”, and “multiple choice exam” as being relevant to the Evaluation attribute for instances of the user learning data 170, and term “online” as being relevant to the Delivery attribute for instances of the user learning data 170.

In certain embodiments of the present invention, the educational planning engine 130 identifies an interest in certain topics and/or related educational opportunities by analyzing languages of the calendar events and/or social media postings from the user personal data 175 as above, and updates the user-preferences data 150 with the expressed interested, if no relevant instances are presented in the user learning data 170.

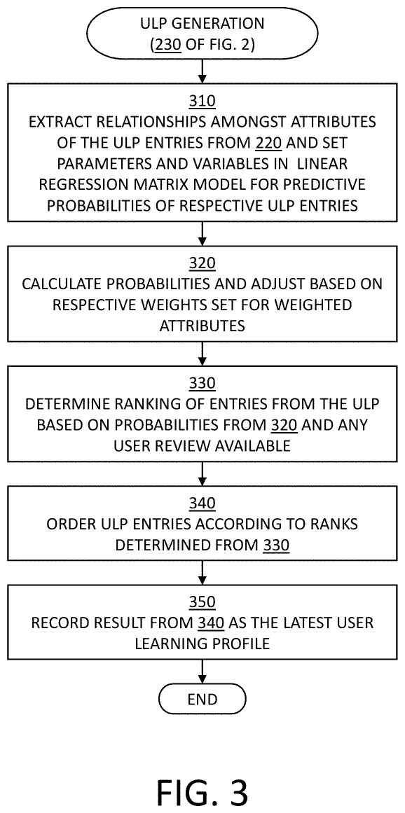

In block 230, the educational planning engine 130 generates the user learning profile 160 with attributes and values as determined from block 220. The education planning engine 130 applies a preconfigured set of values for attributes of the ULP 160 to a linear regression matrix model based on attributes of the ULP 160, in order to analyze how the user 101 would perform in candidate courses. Detailed operations of generating the user learning profile 160 are presented in FIG. 3 and corresponding description. Then, the educational planning engine 130 proceeds with block 240.

In block 240, the educational planning engine 130 produces the course recommendation 190 and presents the produce course recommendation 190 to the user 101 with the ULP resulting from block 230. Then, the educational planning engine 130 proceeds with block 250.

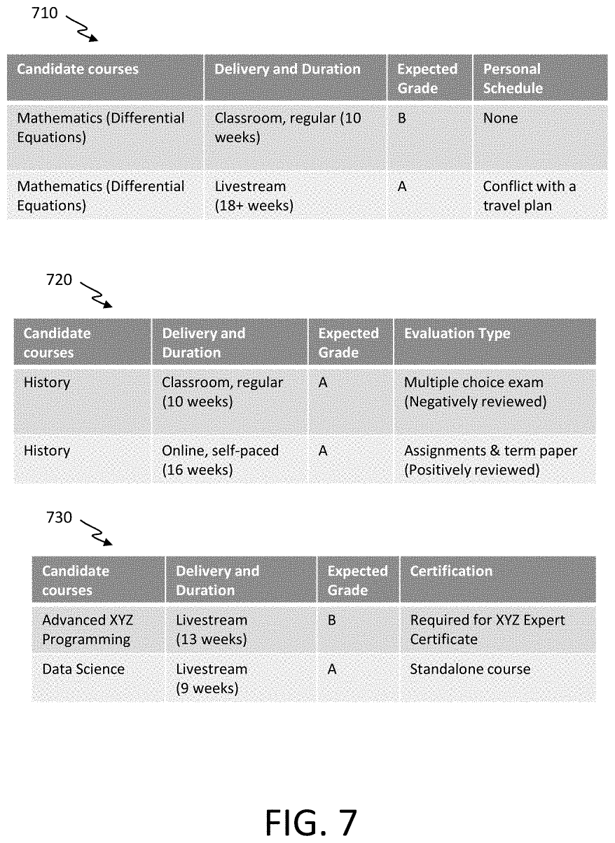

In certain embodiments of the present invention, the educational planning engine 130 searches candidate courses based on the user-topic preferences 150 and certain recommendation criteria as specified in the educational knowledge base 140. In selecting courses for the course recommendation 190, the educational planning engine 130 looks for similarity between the candidate courses and the most highly-ranked entry comparable to the candidate course in the user learning profile 160. An exemplary instance of the user learning profile 160 and the course recommendation 190 as presented to the user 101 are shown in FIGS. 6 and 7.

In block 250, the educational planning engine 130 collects the feedback 199 on the course recommendation 190 from the user 101. The education planning engine 130 subsequently updates various data of the personalized education advisory system 120, including the user-topic preferences 150, the user learning profile 160, and/or the educational knowledge base 140, as being affected by the feedback 199. Then, the educational planning engine 130 terminates processing for the user 101.

FIG. 3 depicts a flowchart for generating the user learning profile (ULP) 160 as performed in block 230 of the educational planning engine 130, in accordance with one or more embodiments set forth herein.

In block 310, the educational planning engine 130 initially sets entries of the user learning profile 160 as formed with the attributes and values determined from block 220. The educational planning engine 130 subsequently extracts certain relationships between attributes of the ULP 160 and sets parameters and variables of a linear regression matrix model with respective attributes of the ULP 160, in order to calculate respective probabilities indicating how accurately the entries in the ULP 160 would predict an outcome of a similar candidate course that will be taken by the user 101 in the future. Then, the educational planning engine 130 proceeds with block 320.

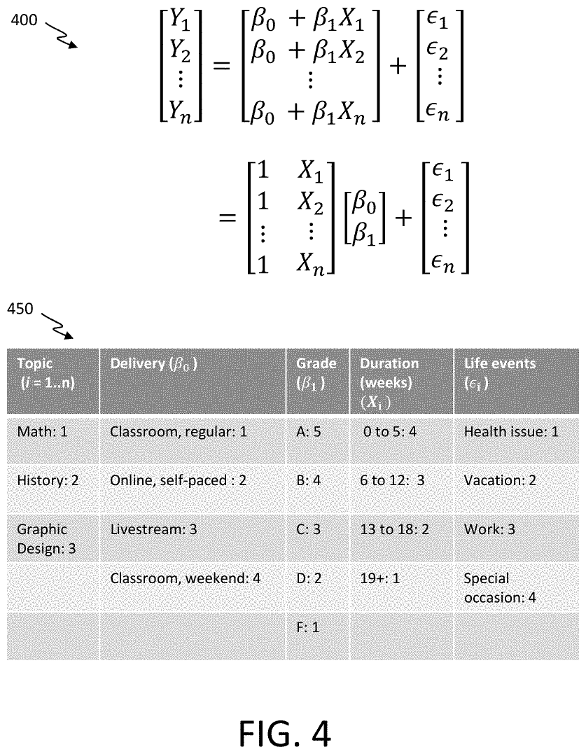

In certain embodiments of the present invention, the educational planning engine 130 has an exemplary linear regression matrix model 400 and an exemplary set of predefined values for attributes 450 specified as shown in FIG. 4.

In block 320, the educational planning engine 130 calculates the probabilities as formulated in the linear regression matrix model, and adjusts the calculated probabilities based on respective predefined weights set for weighted attributes, by calculating the probabilities in an iterative loop. Then, the educational planning engine 130 proceeds with block 330.

In certain embodiments of the present invention, the educational planning engine 130 has Year, Relevancy, and Sentiment attributes of the user learning profile 160 entries configured for weighting, as shown in FIG. 5. In the same embodiment of the present invention, the educational planning engine 130, by use of differentiated weight values for various value ranges of the Year attribute, hypothesizes that a more recent user learning data record would more accurately predict an outcome of a similar candidate course, rather than an older user learning data record. Similarly, the education planning engine 130, by use of differentiated weight values for various values of the Relevancy attribute, hypothesizes that a user learning data record has more predictive value on similar candidate courses if the user learning data record is job related than unrelated, or if the user learning data record is of a topic that is frequently taken than not. Also, the education planning engine 130, by use of differentiated weight values for various values of the Sentiment attribute, hypothesizes that a user learning data record has more predictive value on similar candidate courses if the user learning data record is on a course that the user 101 had positively responses than not.

In block 330, the educational planning engine 130 determines ranking of entries of the user learning profile 160 based on respective probability values resulting from block 320 and any user review available. Then, the educational planning engine 130 proceeds with block 340.

In block 340, the educational planning engine 130 orders the entries of the user learning profile 160 according to the ranks determined from block 330. Then, the educational planning engine 130 proceeds with block 350.

In block 350, the educational planning engine 130 records the entries of the user learning profile 160, as ordered by respective ranks from block 340. Then, the educational planning engine 130 concludes generating the user learning profile 160 and proceeds with block 240 of FIG. 2.

FIG. 4 depicts an exemplary linear regression matrix model 400 with parameters, in accordance with one or more embodiments set forth herein.

In certain embodiments of the present invention, the educational planning engine 130 has the exemplary linear regression matrix model 400, which is a general form of a linear regression matrix. X is a design matrix, representing n number of predictors, also referred to as explanatory variables. β is a vector of parameters, which specifies how the predictors would contribute the responses. ϵ is a vector of error terms, and Y is a vector of n number of responses corresponding respectively to each predictor X, in combination with respective values of β and ϵ.

A table 450 is an exemplary set of predefined values for attributes. The Topic column represents a set of exemplary values for topics appearing in the user learning data 170 and respective numerical values assigned for each topic, where {Math=1, History=2, Graphic Design=3}. Each topic can be a category for more than one subtopic, which is a subject of an educational course and/or program.

The Delivery column represents a set of exemplary values for an intercept parameter (β₀), which is set for various media/methods in which the educational course and/or program is held, where some exemplary values are {Classroom, regular=1, Online, self-paced=2, Livestream=3, Classroom, weekend=4}. The Grade column represents a slope parameter (β₁), which is set for a grade that the user 101 had earned in the past.

The Duration column represents a set of exemplary values for a predictor (X), which is set for various durations, in a number of weeks, of each course and/or program that had been taken, where the values are set as {4 for 0 to 5 weeks, 3 for 6 to 12 weeks, 2 for 13 to 18 weeks, 1 for 19 weeks or longer}. This embodiment hypothesizes that the duration of a course is indicative of how predictive the course would be in future performances of the user 101 in similar courses. Fifth column Life events represents a set of exemplary values for the error terms (ϵ), which is set for various life events that had occurred during the course and/or program in the user learning data 170, where the values are set as {1 for Health-related events, 2 for Vacations, 3 for Work, 4 for Special occasions}.

FIG. 5 depicts an exemplary weight scheme 500 in the same embodiment as FIG. 4, indicating how each topic to be ranked for generating the course recommendations, in accordance with one or more embodiments set forth herein.

The exemplary weight scheme 500 is presented in a table form in FIG. 5, for three (3) weighted attributes for a certain group of values and respective weights corresponding to the values of each weighted attribute. The educational planning engine 130 applies, by multiplying, respective weights corresponding to the values for the weighted attributes of a topic to the probability of the topic in adjusting the probability of the topic in block 320 of FIG. 3.

In the exemplary weight scheme 500, the first column shows that the weight scheme has five (5) set weight values of {1, 0.75, 0.5, 0.25, 0}. The Year of completion column has five (5) ranges of years respectively corresponding to each weight value as set in the first column. The Year of completion column shows that the weights for respective ranges of years will be greater for topics that had been completed more recently. The Year of completion column shows that and any topics in a course taken more than ten (10) years ago, that is, (t−10), would not be considered as the probability of the topic will be adjusted to zero (0).

The Relevancy-Frequency column has three (3) categories of {Job-related/Frequently, Hobby/Often, One time/Rarely} have weights of 1, 0.5, and 0, respectively. As noted above, for any topics that the user 101 does not have a continued interest from the Relevancy-Frequency column, the educational planning engine 130 would not consider the topic by adjusting the probability of the topic to zero (0). Similarly, the Review/Sentiment column has three (3) categories of {Positive, Neutral, Negative}, which respectively corresponds to weights of 1, 0.5, and 0. Accordingly, the educational planning engine 130 would not consider the topics to which the user 101 has negative sentiment or had reviewed negatively by adjusting the probability of the topic to zero (0).

FIG. 6 depicts an exemplary user learning profile 600 in the same embodiment as above, in accordance with one or more embodiments set forth herein.

The exemplary user learning profile 600 is as generated in block 230 by the educational planning engine 130. As noted, the educational planning engine 130 analyzes input data from the user learning data 170 and the user personal data 175 and selects attributes of the user learning profile 160 in block 220 of FIG. 2. The exemplary user learning profile 600 includes attributes of Topic, Delivery, Grade, Year, Duration, Sentiment, and Life Events, where attributes of Topic, Delivery, Grade, Year, and Duration are obtained from the user learning data 170, and where attributes of Sentiment and Life Events are obtained from the user personal data 175.

The exemplary user learning profile 600 presents four (4) entries as compiled from the user learning data 170 and the user personal data 175. A first entry in the first row of the exemplary user learning profile 600 represents a “Mathematics (Calculus)” course that the user 101 took in year 2015, as represented in Topic and Year attributes, respectively. Topic attribute of the first entry indicates that the calculus course is classified under a topic of mathematics in the exemplary user learning profile 600. The course was held online and self-paced, as represented in Delivery attribute of the first entry. Duration attribute value of eight (8) weeks indicates that the course of the first entry had been held over a period of eight weeks. An “A” value for Grade attribute of the first entry indicates that the user 101 aced the course. Sentiment attribute has a “Positive” value, indicating that the user 101 provided a positive review for the course of the first entry. Life events attribute has a “summer vacation” value, indicating that the user 101 took the course during a summer vacation.

A second entry in the second row of the exemplary user learning profile 600 represents a “Mathematics (Geometry)” course that the user 101 took in year 2013, as represented in Topic and Year attributes, respectively. Topic attribute of the first entry indicates that the geometry course is classified under a topic of mathematics in the exemplary user learning profile 600. The course was held in a regular classroom format, as represented in Delivery attribute of the second entry. Duration attribute value of eighteen (18) weeks indicates that the course of the second entry had been held over a period of eighteen weeks. A “B−” value for Grade attribute of the second entry indicates that the user 101 earned B− for the course. Sentiment attribute has a “Neutral” value, indicating that the user 101 provided a neutral review for the course of the second entry. Life events attribute has a “spring break; allergy outbreak” value, indicating events occurred during the course.

A third entry in the third row of the exemplary user learning profile 600 represents a “History” course that the user 101 took in year 2014, as represented in Topic and Year attributes, respectively. The course was held in a livestream format, as represented in Delivery attribute of the third entry. Duration attribute value of twelve (12) weeks indicates that the course of the third entry had been held over a period of twelve weeks. A “B” value for Grade attribute of the third entry indicates that the user 101 earned B for the history course. Sentiment attribute has a “Neutral” value, indicating that the user 101 provided a neutral review for the history course of the third entry. Life events attribute has a “wisdom teeth removed” value, indicating what happened during the course for the user 101.

A fourth entry in the fourth row of the exemplary user learning profile 600 represents a “Graphic Design” course that the user 101 took in year 2013, as represented in Topic and Year attributes, respectively. The course was held in a regular classroom format, as represented in Delivery attribute of the fourth entry. Duration attribute value of eighteen (18) weeks indicates that the course of the fourth entry had been held over a period of eighteen weeks. A “C” value for Grade attribute of the fourth entry indicates that the user 101 earned C for the graphic design course. Sentiment attribute has a “Negative” value, indicating that the user 101 provided a negative review for the graphic design course of the fourth entry. Life events attribute has a “car accident” value, indicating what happened during the course for the user 101.

The educational planning engine 130 adjusts respective probability presenting predictive value according to the exemplary weight scheme 500 of FIG. 5. For example, the educational planning engine 130 discovers that the user 101 has a job relevant with topics of mathematics, and accordingly, a weight of one (1) is applied to the first entry of “Mathematics (Calculus)” course and the second entry of “Mathematics (Geometry)” course. Similarly, the educational planning engine 130 applies a weight of zero (0) to the fourth entry of “Graphic Design” course according to the exemplary weight scheme 500, as the sentiment attribute has a value of “Negative”. For another example, the educational planning engine 130 removes all entries that had been taken ten (10) years ago, that is before year 2008 when t=2018, as the weight of zero (0) would be applied to courses have the Year value less than 2008.

FIG. 7 depicts exemplary course recommendations as in the same embodiment as above, in accordance with one or more embodiments set forth herein.

A first exemplary course recommendation 710 presents two comparable candidate courses on a same topic of “Mathematics (Differential Equations)” with distinctive values for Delivery, Duration, Expected Grades, and Personal Schedules attributes. As noted, a value of Delivery attribute indicates a method in which the course is held and a value of Duration attribute indicates how long the course will be held. Values for Expected Grade attribute are calculated by the educational planning engine 130 based on the user learning profile 160, as Grade of certain courses in the user learning profile 160 can be predictive of a comparable future courses to a certain level. Values for Personal Schedule attribute are compiled from the calendar events in the user personal data 175 or other input by the user 101, and checked against the begin date and the ending date of candidate courses. The values of Duration attributes for the candidate courses can be calculated from the begin date and the end date of respective candidate courses as specified by respective program providers and/or faculties.

A first candidate course on the topic of “Mathematics (Differential Equations)” in the first exemplary course recommendation 710 is specified as being delivered in a regular classroom format for ten (10) weeks, and the user 101 is likely to receive a grade of B, but no personal events that can interfere with the course hours are scheduled. A second candidate course on the topic of “Mathematics (Differential Equations)” in the first exemplary course recommendation 710 is specified as being delivered in a livestream format for a period longer than eighteen (18) weeks, and the user 101 is likely to receive a grade of A, but a travel plan is set during the period of the course. The educational planning engine 130 can further check the user-topic preferences 150 and present respective notes on the delivery method and the duration of the candidate courses.

A second exemplary course recommendation 720 presents two comparable candidate courses on a same topic of “History” with distinctive values for Delivery, Duration, Expected Grades, and Evaluation type attributes.

A first candidate course on the topic of “History” in the second exemplary course recommendation 720 is specified as being delivered in a regular classroom format for ten (10) weeks, and the user 101 is likely to receive a grade of A, but the course description states that the grade will be based on multiple choice exam. The user-topic preferences 150 indicates that the user 101 had reviewed multiple choice exams for history courses negatively in the past, and prefers other evaluation methods. A second candidate course on the topic of “History” in the second exemplary course recommendation 720 is specified as being delivered in a self-paced, online format for a period of sixteen (16) weeks, and the user 101 is likely to receive a grade of A, by submitting assignments and term papers. The educational planning engine 130 checks any instances relevant to evaluation methods in the user-topic preferences 150 and presents the preferences notes on evaluation with both candidate courses.

A third exemplary course recommendation 730 presents two comparable candidate courses on two (2) distinctive topics with distinctive values for Delivery, Duration, Expected Grades, and Certification attributes.

A first candidate course on the topic of “Advanced XYZ Programming” in the third exemplary course recommendation 730 is specified as being delivered in a livestream format for thirteen (13) weeks, and the user 101 is likely to receive a grade of B. The course is the last required course that the user 101 needs to take to get a certification as an XYZ expert, according to the user learning data 170 and an XYZ expert certification description as stored in the educational knowledge base 140. The user-topic preferences 150 indicates that the user 101 has a goal of earning the XYZ expert certification. A second candidate course on the topic of “Data Science” in the third exemplary course recommendation 730 is specified as being delivered in a livestream format for a period of nine (9) weeks, and the user 101 is likely to receive a grade of A. The educational planning engine 130 discovers that the topic of “Data Science” is comparable to the topic of “Advanced XYZ Programming” based on respective schedules, delivery methods, substances of the courses, and the level of interest/relevancy as shown in the user-topic preferences 150.

Certain embodiments of the present invention may offer various technical computing advantages, including the use of cognitive analytics and/or natural language tools to comprehensively parse and tag unstructured documents and/or program outputs and to generate value-attribute pairs of the user learning profile by combining common attributes from the user learning data and the user personal data. Certain embodiments of the present invention utilize a linear regression matrix model for relating various attributes of the user learning profile in order to calculate how each entry in the user learning profile is likely to predict an outcome of a candidate course, subject to recommendation. The course recommendation is generated based on the user-topic preferences and the predictive probabilities of past courses in the user learning data that are comparable to respective candidate courses. Certain embodiments of the present invention may be implemented by use of a cloud platform/data center in various types including a Software-as-a-Service (SaaS), Platform-as-a-Service (PaaS), Database-as-a-Service (DBaaS), and combinations thereof based on types of subscription. The personalized education advisory service can be provided for subscribed individual students as well as educational institutes in need from any location in the world.

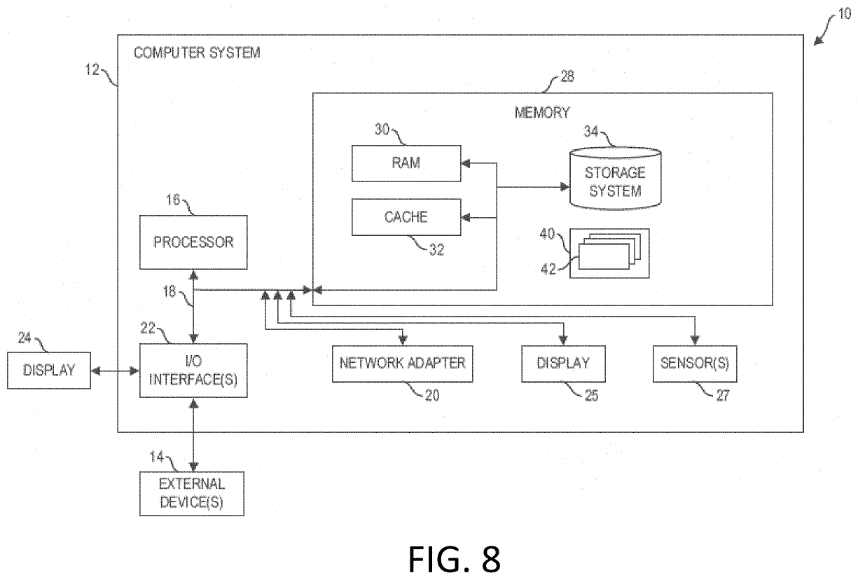

FIGS. 8-10 depict various aspects of computing, including a cloud computing system, in accordance with one or more aspects set forth herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 8, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile memory device (e.g., a “thumb drive”, “external hard drive”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the educational planning engine 130 and the personalized education advisory system 120 of FIG. 1, respectively. Program processes 42, as in the educational planning engine 130 of the personalized education advisory system 120 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18.

In addition to or in place of having external devices 14 and the display 24, which can be configured to provide user interface functionality, computing node 10 in one embodiment can include another display 25 connected to bus 18. In one embodiment, the display 25 can be configured as a touch screen render and can be configured to provide user interface functionality, e.g. can facilitate virtual keyboard functionality and input of total data. Computer system 12 in one embodiment can also include one or more sensor device 27 connected to bus 18. One or more sensor device 27 can alternatively or in addition be connected through I/O interface(s) 22. The one or more sensor device 27 can include a Global Positioning Sensor (GPS) device in one embodiment and can be configured to provide a location of computing node 10. In one embodiment, the one or more sensor device 27 can alternatively or in addition include, e.g., one or more of a camera, a gyroscope, a temperature sensor, a humidity sensor, a pulse sensor, a blood pressure (BP) sensor or an audio input device.

It should be understood that although not shown, other hardware and/or software components could be used in conjunction with computer system 12. Examples, include, but are not limited to: microcode, device drivers, redundant processors, external disk drive arrays, RAID systems, tape drives, and data archival storage systems, etc.

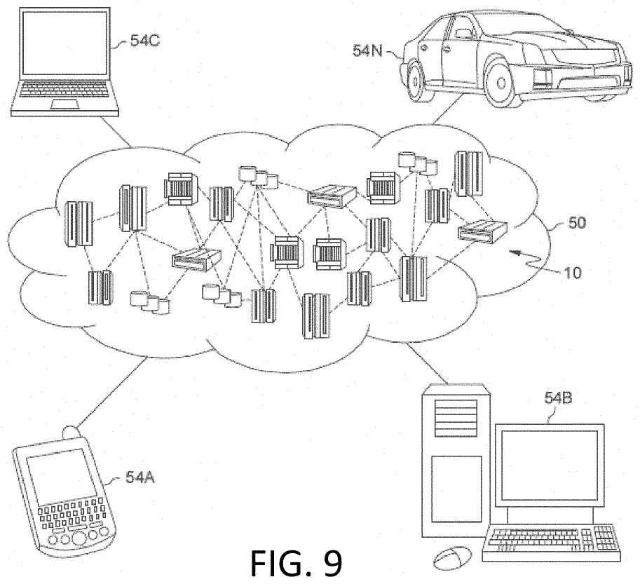

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

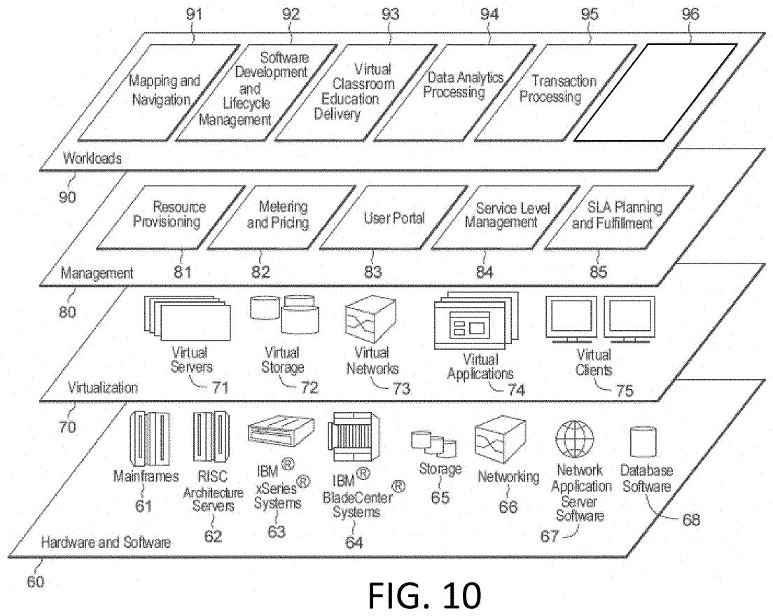

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for the personalized education services as provided by the personalized education advisory system 96, as described herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method, comprising:
collecting, by one or more processor, instances of user learning data and user personal data for a user;
analyzing, by the one or more processor, the collected instances the user learning data and the user personal data for common attributes in the collected instances;
generating, by the one or more processor, a user learning profile for the user based on the result from the analyzing by modeling with a linear regression matrix;
producing, by the one or more processor, one or more course recommendation based on the generated user learning profile, user-topic preferences provided by the user, and contents of an educational knowledge base;
presenting, by the one or more processor, the user learning profile and the course recommendation to the user; and
updating, by the one or more processor, the user learning profile, the user-topic preferences, and selected contents of the educational knowledge base that are affected by a feedback from the user, on the user learning profile and on the course recommendation.

2. The computer implemented method of claim 1, the generating comprising:
extracting relationships amongst attributes of the user learning data and the user personal data that forms an entry of the user learning profile, wherein the user learning profile includes one or more entry including the entry; and
setting parameters and variables in the linear regression matrix with respectively selected attributes in the one or more entry of the user learning profile, wherein response variables in the linear regression matrix indicate predictive probabilities of respective entries in the user learning profile on outcomes of candidate courses that are respectively comparable to courses represented in the entries.

3. The computer implemented method of claim 2, further comprising:
calculating a predictive probability of the entry in the user learning profile for a candidate course that is comparable to a course represented by the entry, wherein the candidate course is a member of a set of candidate courses, and wherein the course recommendation from the producing includes the candidate course; and
adjusting the predictive probability of the entry from the calculating by multiplying a weight corresponding to a preconfigured value for a selected attribute in the user learning profile in a weight scheme for the user learning profile, wherein the weight scheme specifies sets of values for respective attributes in the user learning profile and respective weights corresponding to each value in for respective attributes.

4. The computer implemented method of claim 3, wherein the user learning profile include attributes of topic, year of completion, delivery, duration, sentiment, and life event, and wherein the weight scheme is specified for the year of completion attribute, reducing a predictive probability associated with an aged entry by use of the year of completion attribute.

5. The computer implemented method of claim 3, further comprising:
determining respective ranks for entries in the user learning profile, based on respective predictive probabilities of the entries in the user learning profile from the adjusting;
ordering the entries in the user learning profile according to the determined ranks such that the user learning profile would access the entries in order of predictive probabilities associated with respective entries; and
recording the user learning profile from the ordering as the latest user learning profile for the user.

6. The computer implemented method of claim 1, wherein the user learning data include past education records describing aspects of one or more educational programs taken by the user, wherein the aspects include a topic, a date and duration of completion, a delivery format, and characteristics of an educational program.

7. The computer implemented method of claim 1, wherein the user personal data include calendar records describing schedules and events of the user in the past and in the future, social media postings, and social media interactions, which have respective values relevant to any topic and/or date in the instances of the user learning data of the user.

8. A computer program product comprising:
a computer readable storage medium readable by one or more processor and storing instructions for execution by the one or more processor for performing a method comprising:
collecting instances of user learning data and user personal data for a user;
analyzing the collected instances the user learning data and the user personal data for common attributes in the collected instances;
generating a user learning profile for the user based on the result from the analyzing by modeling with a linear regression matrix;
producing one or more course recommendation based on the generated user learning profile, user-topic preferences provided by the user, and contents of an educational knowledge base;
presenting the user learning profile and the course recommendation to the user; and
updating the user learning profile, the user-topic preferences, and selected contents of the educational knowledge base that are affected by a feedback from the user, on the user learning profile and on the course recommendation.

9. The computer program product of claim 8, the generating comprising:
extracting relationships amongst attributes of the user learning data and the user personal data that forms an entry of the user learning profile, wherein the user learning profile includes one or more entry including the entry; and
setting parameters and variables in the linear regression matrix with respectively selected attributes in the one or more entry of the user learning profile, wherein response variables in the linear regression matrix indicate predictive probabilities of respective entries in the user learning profile on outcomes of candidate courses that are respectively comparable to courses represented in the entries.

10. The computer program product of claim 9, further comprising:
calculating a predictive probability of the entry in the user learning profile for a candidate course that is comparable to a course represented by the entry, wherein the candidate course is a member of a set of candidate courses, and wherein the course recommendation from the producing includes the candidate course; and
adjusting the predictive probability of the entry from the calculating by multiplying a weight corresponding to a preconfigured value for a selected attribute in the user learning profile in a weight scheme for the user learning profile, wherein the weight scheme specifies sets of values for respective attributes in the user learning profile and respective weights corresponding to each value in for respective attributes.

11. The computer program product of claim 10, wherein the user learning profile include attributes of topic, year of completion, delivery, duration, sentiment, and life event, and wherein the weight scheme is specified for the year of completion attribute, reducing a predictive probability associated with an aged entry by use of the year of completion attribute.

12. The computer program product of claim 10, further comprising:
determining respective ranks for entries in the user learning profile, based on respective predictive probabilities of the entries in the user learning profile from the adjusting;
ordering the entries in the user learning profile according to the determined ranks such that the user learning profile would access the entries in order of predictive probabilities associated with respective entries; and
recording the user learning profile from the ordering as the latest user learning profile for the user.

13. The computer program product of claim 8, wherein the user learning data include past education records describing aspects of one or more educational programs taken by the user, wherein the aspects include a topic, a date and duration of completion, a delivery format, and characteristics of an educational program.

14. The computer program product of claim 8, wherein the user personal data include calendar records describing schedules and events of the user in the past and in the future, social media postings, and social media interactions, which have respective values relevant to any topic and/or date in the instances of the user learning data of the user.

15. A system comprising:
a memory;
one or more processor in communication with memory; and
program instructions executable by the one or more processor via the memory to perform a method comprising:
collecting instances of user learning data and user personal data for a user;
analyzing the collected instances the user learning data and the user personal data for common attributes in the collected instances;
generating a user learning profile for the user based on the result from the analyzing by modeling with a linear regression matrix;
producing one or more course recommendation based on the generated user learning profile, user-topic preferences provided by the user, and contents of an educational knowledge base;
presenting the user learning profile and the course recommendation to the user; and
updating the user learning profile, the user-topic preferences, and selected contents of the educational knowledge base that are affected by a feedback from the user, on the user learning profile and on the course recommendation.

16. The system of claim 15, the generating comprising:
extracting relationships amongst attributes of the user learning data and the user personal data that forms an entry of the user learning profile, wherein the user learning profile includes one or more entry including the entry; and
setting parameters and variables in the linear regression matrix with respectively selected attributes in the one or more entry of the user learning profile, wherein response variables in the linear regression matrix indicate predictive probabilities of respective entries in the user learning profile on outcomes of candidate courses that are respectively comparable to courses represented in the entries.

17. The system of claim 16, further comprising:
calculating a predictive probability of the entry in the user learning profile for a candidate course that is comparable to a course represented by the entry, wherein the candidate course is a member of a set of candidate courses, and wherein the course recommendation from the producing includes the candidate course; and
adjusting the predictive probability of the entry from the calculating by multiplying a weight corresponding to a preconfigured value for a selected attribute in the user learning profile in a weight scheme for the user learning profile, wherein the weight scheme specifies sets of values for respective attributes in the user learning profile and respective weights corresponding to each value in for respective attributes, wherein the user learning profile include attributes of topic, year of completion, delivery, duration, sentiment, and life event, and wherein the weight scheme is specified for the year of completion attribute, reducing a predictive probability associated with an aged entry by use of the year of completion attribute.

18. The system of claim 17, further comprising:
determining respective ranks for entries in the user learning profile, based on respective predictive probabilities of the entries in the user learning profile from the adjusting;
ordering the entries in the user learning profile according to the determined ranks such that the user learning profile would access the entries in order of predictive probabilities associated with respective entries; and
recording the user learning profile from the ordering as the latest user learning profile for the user.

19. The system of claim 15, wherein the user learning data include past education records describing aspects of one or more educational programs taken by the user, wherein the aspects include a topic, a date and duration of completion, a delivery format, and characteristics of an educational program.

20. The system of claim 15, wherein the user personal data include calendar records describing schedules and events of the user in the past and in the future, social media postings, and social media interactions, which have respective values relevant to any topic and/or date in the instances of the user learning data of the user.
